(19) United States
(12) Patent Application Publication
(10) Pub. No.: US 2023/0273039 A1
(43) Pub. Date: Aug. 31, 2023

(54) CLOUD BASED NAVIGATION FOR VISION IMPAIRED PEDESTRIANS

(71) Applicant: ZF FRIEDRICHSHAFEN AG, Friedrichshafen (DE)

(72) Inventors: Mohammad ALSHARIF, Tettnag (DE); Ilker BAGCI, Ravensburg (DE); Hubert BICHELMEIER, Friedrichshafen (DE); Istvan HEGEDÜS-BITE, Eriskirch (DE); Bastian HUBRACHT, Friedrichshafen (DE); Timm Christoph MUNTEL, Friedrichshafen (DE); Gowtham PERUMALSAMY, Markdorf (DE)

(21) Appl. No.: 17/682,985

(22) Filed: Feb. 28, 2022

(51) Int. Cl. G01C 21/36; G06V 20/64; G06F 1/16

(52) U.S. Cl. CPC G01C 21/3652; G06V 20/64; G06F 1/163

(57) ABSTRACT

A pedestrian navigation system may include at least one vehicle sensor configured to acquire image data of an environment surrounding a vehicle, and a processor programmed to receive the image data, receive a pedestrian location from a user device associated with a pedestrian, determine if the image data indicates presence of an obstruction at the pedestrian location, and transmit instructions to issue an alert via the user device in response to the image data indicating the presence of the obstruction.

### FIELD OF THE INVENTION

Described herein are systems and methods for cloud based navigation for vision impaired pedestrians.

### BACKGROUND

Various devices exist to aid visually impaired individuals perform every day tasks. These devices may include glasses, canes, watches, etc. These devices may be capable of receiving wireless communication. However, updated information and better and more accurate environment data may be desired to further aid the user.

### SUMMARY

A pedestrian navigation system may include at least one vehicle sensor configured to acquire image data of an environment surrounding the vehicle, and a processor programmed to receive the image data, receive a pedestrian location from a user device associated with the pedestrian, determine if the image data indicates the presence of an obstruction at the pedestrian location, and transmit instructions to issue an alert via the user device in response to the image data indicating the presence of an obstruction.

A method for a detecting the presence of an object along a pedestrian path may include receiving image data of an environment surrounding a vehicle, receiving a pedestrian location from a user device associated with the pedestrian, determining if the image data indicates the presence of an obstruction at the pedestrian location, and transmitting instructions to issue an alert to the user device in response to the image data indicating the presence of an obstruction.

A pedestrian navigation system may include at least one camera configured to acquire image data of an environment, and a processor programmed to receive the image data from the camera, receive a pedestrian location from a user device associated with the pedestrian, determine if the image data indicates the presence of an obstruction at the pedestrian location, and transmit instructions to issue an alert via the user device in response to the image data indicating the presence of an obstruction.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 illustrates a block diagram for a cloud based navigation system for vision impaired pedestrians;

FIG. 2 illustrates an example pedestrian and vehicle scenario for the navigation system of FIG. 1; and

FIG. 3 illustrates an example flow chart for a process of the navigation system of FIG. 1.

### DETAILED DESCRIPTION

Vision impaired persons often employ the use of guide dogs, canes, etc., to aid in walking or other every day activities. Advances in technology are also being implemented in every day products to aid users and gather data about the user's surroundings. For example, GOOGLE glasses may integrate a camera as well as read texts or call people from a familiar list of friends. The glasses may support navigation via video telephony. Smartphone sensors may be used with laser scanners that can detect obstacles. Further, the latest smartphones, such as the iPhone, already have Light Detection and Ranging (LIDAR) technology. Other wearable devices, such as shoes, may also include sensors to detect obstacles.

Disclosed herein is a navigation system for integration with certain user devices such as glasses, canes, etc., that may receive obstacle data from a cloud-based server. The obstacle data may be gathered by vehicles as the vehicles driving along a route. The vehicle may capture the data via the vehicle camera, sensors, etc., and catalog the obstacle data with the known location of the detected obstacle. Then, as a user is walking or otherwise within the vicinity of the detected object, the server, using artificial intelligence, machine learning, and various other processes, may send an alert to the user device to alert the user of that obstacle. This obstacle, such as a park bench arranged on a sidewalk, or an intersection, may not be otherwise visible or known by a vision impaired user. Further, other third party devices may also be used to gather obstacle data.

The vehicles may be used to create a network of data sources for pedestrians or other non-automotive users to use at a later time. Objects not necessarily on a road or relevant to the vehicle's route may still be recognized within the vehicle's field of view. This acquired obstacle data may be used to warn users of the upcoming obstacle, as well as generate off-road navigation. Wearable devices, user device such as mobile phones, internet of things (IoT), etc., may all be used to create a user's digital environment.

Because most of the processing and aggregating of the obstacle images and data are done off-board by a cloud-based server, the processing performance of the user devices does not need to be substantial and the need for bandwidth or extensive downloads is not necessary. Accordingly, while vehicles may be the main source of image data collection, any device, including the user devices, may collect the image data. The various sources from which the data is collected aids in the robustness of the system's capabilities. The data may be used to determine when and if to generate an alert to the user via the user device. In some examples, user feedback, either through the user device or another device or mechanism, may also be received to confirm the accuracy of the obstacle data.

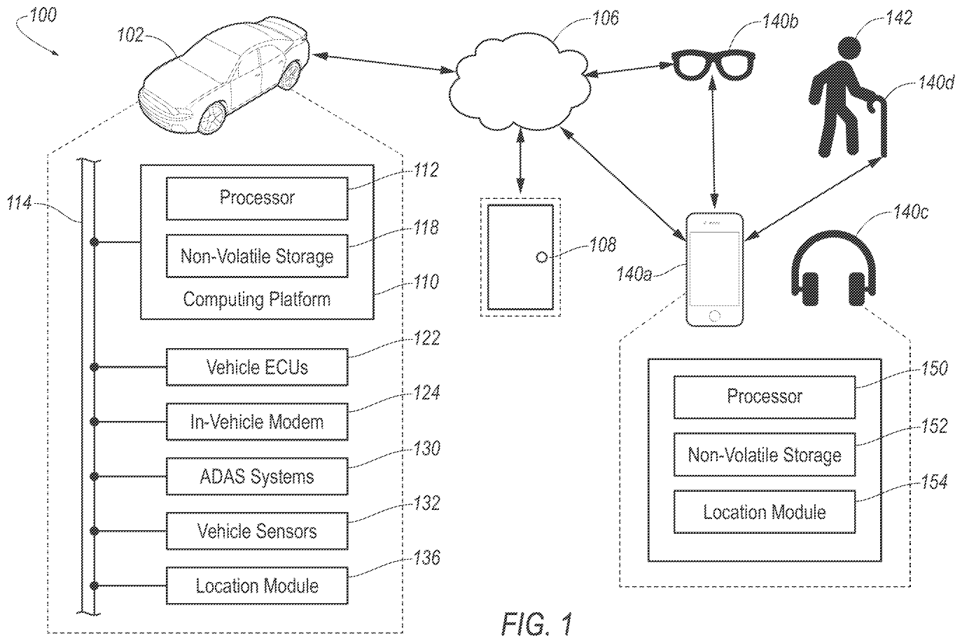

FIG. 1 illustrates a block diagram for a cloud based navigation system 100 for vision impaired pedestrians. The system 100 may be designed for a vehicle 102 configured to transport passengers. The vehicle 102 may include various types of passenger vehicles, such as crossover utility vehicle (CUV), sport utility vehicle (SUV), truck, recreational vehicle (RV), boat, plane or other mobile machine for transporting people or goods. The vehicle 102 may be a bus and be part of a fleet where various drivers are responsible for the vehicle 102 at various times.

The vehicle 102 may be autonomous, partially autonomous, self-driving, driverless, or driver-assisted vehicles. The vehicle 102 may be an electric vehicle (EV), such as a battery electric vehicle (BEV), plug-in hybrid electric vehicle (PHEV), hybrid electric vehicle (HEVs), etc. The vehicle 102 may be configured to include various types of components, processors, and memory, and may communicate with a communication network 106. The communication network 106 may be referred to as a “cloud” and may involve data transfer via wide area and/or local area networks, such as the Internet, global navigation satellite system (GNSS), cellular networks, Wi-Fi, Bluetooth, etc. The communication network 106 may provide for communication between the vehicle 102 and an external or remote server 108 and/or database, as well as other external applications, systems, vehicles, etc. This communication network 106 may provide data and/or services to the vehicle 102 such as navigation, music or other audio, program content, marketing content, software updates, system updates, Internet access, speech recognition, cognitive computing, artificial intelligence, etc.

The remote server 108 may include one or more computer hardware processors coupled to one or more computer storage devices for performing steps of one or more methods as described herein (not shown). These hardware elements of the remote server 108 may enable the vehicle 102 to communicate and exchange information and data with systems and subsystems external to the vehicle 102 and local to or onboard the vehicle 102.

The vehicle 102 may include a computing platform 110 having one or more processors 112 configured to perform certain instructions, commands and other routines as described herein. Internal vehicle networks 114 may also be included, such as a vehicle controller area network (CAN), an Ethernet network, and a media oriented system transfer (MOST), etc. The internal vehicle networks 114 may allow the processor 112 to communicate with other vehicle systems, such as an in-vehicle modem 124, and various vehicle electronic control units (ECUs) 122 configured to corporate with the processor 112.

The processor 112 may execute instructions for certain vehicle applications, including navigation, infotainment, climate control, etc. Instructions for the respective vehicle systems may be maintained in a non-volatile manner using a variety of types of computer-readable storage medium 118. The computer-readable storage medium 118 (also referred to herein as memory 118, or storage) includes any non-transitory medium (e.g., a tangible medium) that participates in providing instructions or other data that may be read by the processor 112. Computer-executable instructions may be compiled or interpreted from computer programs created using a variety of programming languages and/or technologies, including, without limitation, and either alone or in combination, Java, C, C++, C #, Objective C, Fortran, Pascal, Java Script, Python, Perl, and PL/structured query language (SQL).

Vehicle ECUs 122 may be incorporated or configured to communicate with the computing platform 110. As some non-limiting possibilities, the vehicle ECUs 122 may include a powertrain control system, a body control system, a radio transceiver module, a climate control management system, human-machine interface (HMI)'s, etc. The in-vehicle modem 124 may be included to communicate information between the computing platform 110, the vehicle 102, and the remote server 108. The memory 118 may maintain the data about the vehicle 102, as well as specific information gathered from vehicle sensors 132.

The vehicle 102 may also include a wireless transceiver (not shown), such as a BLUETOOTH module, a ZIGBEE transceiver, a Wi-Fi transceiver, an IrDA transceiver, a radio frequency identification (RFID) transceiver, etc.) configured to communicate with compatible wireless transceivers of various user devices, as well as with the communication network 106.

The vehicle 102 may include various sensors 132 and input devices as part of other vehicle systems that may also be used by the driver behavior monitoring system 100. For example, the vehicle 102 may include at least one microphone configured to acquire ambient noise, Noise, vibration, and harshness (NVH) noise, etc.

The sensors 132 may include various ones of imaging sensors configured to detect image data and/or object detection data. The imaging sensors may be configured to capture and detect objects external to the vehicle 102 and transmit the data to the server 108 via the communications network 106. In one example, the imaging sensors may be cameras configured to acquire images of an area adjacent the vehicle.

For example, such sensors 132 may include, LiDAR, a radio detection and ranging (RADAR), a laser detection and ranging (LADAR), a sound navigation and ranging (SONAR), ultrasonic sensors, one or more cameras (e.g., visible spectrum cameras, infrared cameras, etc.), temperature sensors, position sensors (e.g., global positioning system (GPS), etc.), location sensors, motion sensor, etc. The sensor data can include information that describes the location of objects within the surrounding environment of the vehicle 102. The sensor data may also include image data including an image or indication of an object or obstruction. In one example, an obstruction may be an object, such as a large rock, tree, bush, bench, etc., located in the field of view of the vehicle 102 and thus detectable by at least one of the sensors 132. The image data may also show an obstruction or an area of interest such as an intersection, cross walk, bike lane, side walk, or any other environmental path or object that may affect the traveling path of the user.

The vehicle 102 may also include a location module 136 such as a GNSS or GPS module configured to provide current vehicle 102 location and heading information. Other location modules 136 may also be used to determine vehicle location and the location data may accompany the image data when transmitted to the server 108.

The server 108 may collect and aggregate the image data. In one example, the server 108 may determine a location of a certain object based on location data associated with the image data. For example, the vehicle 102 may drive past a sidewalk which includes a bench thereon. The image data may indicate the object and based on location services, as well as the relative size of the bench, its position with respect to the sidewalk, etc. The server 108 may maintain this data and create a map of detected objects. That is, the vehicle 102 may collect data about its surrounding areas as the vehicle 102 drives along a route. This data is aggregated and to be used and applied by the server 108.

Although not specifically shown in FIG. 1, the vehicle 102 may include various displays and user interfaces, including heads up displays (HUDs), center console displays, steering wheel buttons, etc. Touch screens may be configured to receive user inputs. Visual displays may be configured to provide visual outputs to the user including outputs related to tire health state. The vehicle 102 may include numerous other systems such as GNSS systems, HMI controls, video systems, etc.

The server 108 may communicate via the communications network 106 with at least one user device 140 (as illustrated at 140a, 140b, 140c, 140d in FIG. 1). The user device 140 may be a device associated with a user 142 and capable of communicating with the server 108. The user device 140 may be a mobile device 140a such as a smart phone, cellular phone, etc. In some examples, the mobile device 140a may be a laptop computer, tablet computer, personal digital assistant, etc.

The user device 140 may also be a wearable device, such as smart glasses 140b capable of providing information visually, typically within the lenses, to the wearer. This superimposed information may provide information in the form of texts, images, etc. The text or images may be transparent or see-through. The smart glasses 140b may also be headset glasses configured to form goggle-like fittings around the user's eyes, such as a virtual reality headset.

The user device 140 may also be a listening device 140c such as headphones, speakers, hearing aids, ear pods, etc. These may be typically warn by the user 142, but also may be speakers adjacent to the user 142.

The user device 140 may also be a walking aid device 140d such as a cane or walker. This may be a device typically used by vision impaired persons to allow others to recognize their hearing impaired status.

While various examples are given for user devices 140, more may be included, such as other wearable device including watches, jewelry, other forms of personal aid devices such as wheelchairs, walkers, etc. Moreover, mobility aided devices such as skate boards, hover boards, electric wheelchairs, to name a few, may also be considered. In some examples, handicap users may also have vision impairment, as well as rely on mobility devices such as wheelchairs. In some cases, the mobility devices themselves could cause vision obstructions, in that the user may be unable to see the ground directly in front of them.

The user device 140 may have a device processor 150 configured to execute instructions for the device 140, such as make phone calls, display information, haptically activate, run applications, emit sounds, and so on. Instructions for the respective systems and applications may be maintained in a non-volatile manner using a variety of types of computer-readable storage medium 152. The computer-readable storage medium 152 (also referred to herein as memory 118, or storage) includes any non-transitory medium (e.g., a tangible medium) that participates in providing instructions or other data that may be read by the processor 150. Computer-executable instructions may be compiled or interpreted from computer programs created using a variety of programming languages and/or technologies, including, without limitation, and either alone or in combination, Java, C, C++, C #, Objective C, Fortran, Pascal, Java Script, Python, Perl, and PL/structured query language (SQL).

The user device 140 may also include a wireless transceiver (not shown), such as a BLUETOOTH module, a ZIGBEE transceiver, a Wi-Fi transceiver, an IrDA transceiver, a RFID transceiver, etc.) configured to communicate with compatible wireless transceivers of various user devices, as well as with the communication network 106. In some examples, the user devices 140 may communicate with each other. That is, the glasses device 140a may pair via short range wireless protocols with the mobile device 140a. In some examples, the mobile device 140a may communicate with the communication network 106 and then with the glasses or other user devices 140b-d, where the user devices 140b-d do not communicate directly with the communication network 106.

The user device 140 may also include a device location module 154 similar to the vehicle 102, such as a GNSS or GPS module configured to provide current user location and heading information. Other device location modules 154 may also be used to determine the user's location based on the user device location. The user device location may be transmitted to the server 108 via the communication network 106.

The server 108 may compare the user location received from the user device 140 with the location of known objects based on the image data received from the vehicle 102. For example, if the user is walking along a sidewalk at a specific location or along a heading, the server 108 may pole the image data to determine whether the image data indicate the presence of any object within a predefined distance of the user location or heading. The predefined distance may be, for example, a certain radius, or distance along the heading. This may be two feet, in one example. In response to this, the server 108 may then transmit an alert or message to the user device 140 to warn the user that there may be an obstruction coming up along his or her route. This may be beneficial for vision impaired users who may be walking with the aid of a mobility cane and may not be aware of the upcoming obstruction.

The server 108 may also use the aggregated data to generate non-driving navigation, such as routes for walking, hiking, etc. This may be facilitated by the image data collected by the vehicle 102 since such data is not typically readily available.

While the examples discussed herein general discuss the vehicle 102 collecting the image data, the user devices 140 may also collect image data. For example, the user devices 140 may include LIDAR, as well as cameras, that may, upon activation, record or detect objects and obstructions. The remote server 108 may receive this non-vehicle data and integrate the image data with that acquired by the vehicle 102 as well as another devices. Thus, a digital environment may be created to allow for a better and more accurate system of providing alerts to the user 142, as well as accurate traveling routes such as walks and hikes. Notably, other user device such as wearable device not associated with the user 142 may also collect image data via cameras, radar, LIDAR, etc. That is, other pedestrians or user may contribute to the digital environment used for the user's benefit.

In some specific examples, non-vehicle data may be provided by other third-party devices or objects. For example, sensors may be embedded into traffic infrastructure devices such as traffic lights, signs, guard rails, etc. These sensors may be cameras configured to capture images of the surrounding areas. This image data may be provided to the server 108 to facilitate object detection. These infrastructure devices may be provided up to date information regarding the environment.

The user 142 may also provide feedback to the server 108, either via the user device 140, or another device capable of communicating with the server 108. For example, the user 142 may receive an alert related to an upcoming object and then confirm that the object was in fact present. This may be done by inputting feedback at one of the user device 140 or an application on the mobile device 140a. The feedback may include some form of tap of the user device 140 such as a double tap on the glasses 140b or the hearing device 140c. The feedback may be provided on a device 140 other than the device that provided the alert. In this example, the alert may be made via the cane 140d, but the user may confirm the presence of an object via the application on the mobile device 140a. The server 108 may use this feedback to update the aggregate data to further confirm the presence of the object, or correct image data that erroneously indicated the presence of the object.

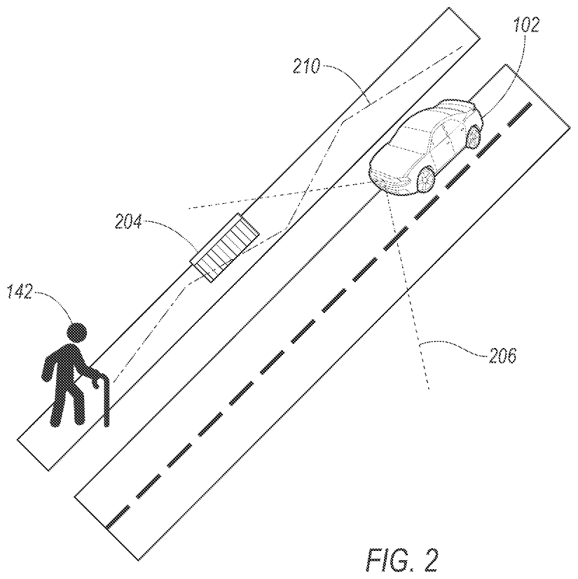

FIG. 2 illustrates an example pedestrian or user 142 and vehicle 102 scenario for the navigation system 100 of FIG. 1. In practice, the vehicle 102 may travel along a road and have a field of view 206. The field of view 206 may be the area adjacent or around the vehicle 102 to which the vehicle sensors 132 may acquire image data. While the field of view 206 is illustrated as being an angular range at the front of the vehicle 102, the field of view 206 may extend up to 360 degrees around the vehicle 102, especially when multiple sensors 132 are used. In one example, several types of sensors 132 are used to collect the image data, and the server 108 may aggregate the data from each type of sensor to determine the location of an object 204. The server 108 may implement various machine learning techniques and artificial intelligence to extract features from the sensor provided data. Such intelligence aids in detecting objects and obstacles based on the received data. In some scenarios, multiple sensor data is compared to detect objects. Furthermore, upon feedback from the user, the algorithms used to detect the objects form the data may be continually updated for increased accuracy and efficiency.

The object 204 may be an obstruction, specific area, hazard or other item that may cause inconvenience or harm to the user 142. The object 204 could be a pot hole, rock, parked car, tree, bush, etc. The object 204 may also be an intersection, cross walk, loading zone, etc. The user 142 may walk along a traveling path 210. The user device 140 may provide the user location, the user's heading, and/or the traveling path to the server 108. The server 108 may then determine if the user location information indicates a path or location within a predefined distance of a previously detected object, such as object 204. This object 204, as explained, is known to the server 108 via the previously gathered image data from the vehicle 102 or other devices.

If the server 108 detects the object 204, which in this example, may be a bench arranged on a side walk, the server 108 may transmit an alert to the user device 140. As explained above, the alert may include a visual alert, haptic alert such as a vibration, an audible alert, etc. The type of alert may depend on the capabilities of the user device 140. The server 108 may customize the alert based on the type of user device 140. For example, the server 108 may send instructions to a cane 140d to issue a haptic alert, while the server 108 may send instructions to a mobile device 140a or glasses 140b to issue a visual alert. The visual or audible alert may indicate “warning, there is an object along your path in 200 ft.,” for example. Visual alerts may include an image of the object or obstruction and/or a textual message. In some examples, more than one type of alert may be instructed and for more than one device.

The user 142 may subscribe to a navigation application and access this application via the mobile device 140a. For example, the user 142 may sign up to receive the alerts from the server 108, set his or her preferences via the application, pair other user devices such as the user devices 140b-d, etc. The application may manage saved routes, user settings, alert settings, etc.

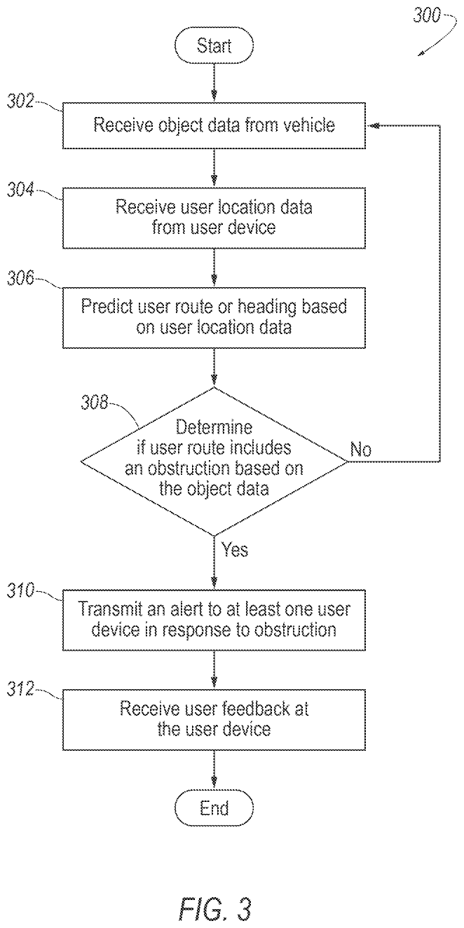

FIG. 3 illustrates an example flow chart for a process 300 of the navigation system of FIG. 1. The process 300 may be carried out by the processors and controllers of the server 108, but may also be carried out by other processors, including other remote processors as well as the processor 150 or processor 112. The process 300 may begin at block 302 where the server 108 may receive image data from the vehicle 102. As explained, this may be required using the existing sensors 132 within the vehicle 102 and may include various forms of data from cameras, LIDARs, sonars, etc. The image data may also be received from other user device 140 and multiple other vehicles in order to fully generate a digital environment of a certain area. The server 108 may maintain this image data and continually aggregate and refine the data based on the most recently received image data.

At block 304, the server 108 may receive location data from the user device 140 indicating the user's location. This location data may include the user's precise location, heading or traveling path.

At block 306, the server 108 may predict the user's route or traveling path if the path is unknown to the user device 140. For example, the server 108 may determine a heading or direction of the user's path based on two location signals. In some examples, the user 142 may be using a map application that provides step by step navigation to the user. This information may be received by the server 108 and thus the user's route may be preestablished.

At block 308, the server 108 may determine whether the user's route includes an obstruction based on the image data. This may include comparing the user's location with previously stored locations of obstructions or objects. In some examples, the server 108 may determine if a detected obstruction is within a predefined distance or predefined radius of the user 142. If an object has been detected, the process 300 proceeds to block 308. If not, the process 300 returns to block 302.

At block 310, the server 108 may transmit instructions for an alert to at least one user device 140 in response to the server 108 determining that an object or obstruction is within a predefined distance of the user 142 or the user's route. This may allow the user to be made aware of the object prior to abutting or approaching the object. This may increase safety and usability of the user devices 140 and allow for a more independent lifestyle for the user 142, especially in the event the user is vision impaired.

At block 312, the server 108 may receive a feedback signal from the user device 140 indicating whether the object was present as predicted or not. As explained, this feedback signal may be optionally provided by the user to aid in increasing the accuracy of the alerts and image data maintained by the server 108.

The process 300 may then end.

Accordingly, a navigation system maintained off-board of a user device may aid in providing additional guidance via the user device to vision impaired users. Normal vision users may also enjoy the benefits of the described systems and methods. No additional equipment may be needed, as sensors typically used and included in the vehicles are used to generate the image data, and continually update the image data as the vehicle 102 is operated. The image data may be transmitted using existing telematics, over the air, cellular data, etc. Further, the processing may be done at the cloud, eliminating the need for the user device to be capable of handling any robust computing or data management.

Furthermore, while an automotive system is discussed in detail here, other applications may be appreciated. For example, similar functionally may also be applied to other, non-automotive cases, e.g. for commercial vehicles, including tractors, combines, dump trucks, excavators, all-terrain vehicles (ATVs), side-by-sides, three-wheel machines, e-bikes, etc.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (erasable programmable read-only memory (EPROM) or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable.

The flowcharts and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A pedestrian navigation system, comprising:
at least one vehicle sensor of a vehicle, the at least one vehicle sensor configured to acquire image data of an environment surrounding the vehicle; and
a processor configured to:
receive the image data,
receive a pedestrian location from a user device associated with a pedestrian,
determine if the image data indicates presence of an obstruction at the pedestrian location, and
transmit instructions to issue an alert via the user device in response to the image data indicating the presence of the obstruction.

2. The system of claim 1, wherein the alert indicates the presence of the obstruction.

3. The system of claim 1, wherein the pedestrian location is a traveling path of the pedestrian.

4. The system of claim 3, wherein the processor determines if the image data indicates the presence of the obstruction at the pedestrian location when the obstruction is within a predefined distance of the pedestrian location.

5. The system of claim 1, wherein the instructions to issue the alert are dependent on a type of the user device.

6. The system of claim 1, wherein the processor is further programmed to receive feedback from the user device regarding the presence of the obstruction.

7. The system of claim 1, wherein the sensor is at least one of a camera, LIDAR, radar, or ultrasonic sensor.

8. The system of claim 1, wherein the image data includes a vehicle location used to derive a location of detected objects within the image data.

9. A method for a detecting presence of an obstruction along a pedestrian path, comprising:
receiving image data of an environment surrounding a vehicle,
receiving a pedestrian location from a user device associated with a pedestrian,
determining if the image data indicates the presence of an obstruction at the pedestrian location, and
transmitting instructions to issue an alert to the user device in response to the image data indicating the presence of the obstruction.

10. The method of claim 9, wherein the alert indicates the presence of the obstruction.

11. The method of claim 9, wherein the pedestrian location is a traveling path of the pedestrian.

12. The method of claim 9, wherein the determining if the image data indicates the presence of the obstruction at the pedestrian location includes determining whether the obstruction is within a predefined distance of the pedestrian location.

13. The method of claim 9, wherein the instructions to issue the alert are dependent on a type of the user device.

14. The method of claim 9, further comprising receiving feedback from the user device regarding the presence of the obstruction.

15. The method of claim 9, wherein the image data is received from at least one of a camera, LIDAR, or ultrasonic sensor.

16. The method of claim 9, wherein the image data includes a vehicle location used to derive a location of detected objects within the image data.

17. A pedestrian navigation system, comprising:
at least one sensor configured to acquire image data of an environment; and
a processor programmed to:
receive the image data from the sensor,
receive a pedestrian location from a user device associated with a pedestrian,
determine if the image data indicates presence of an obstruction at the pedestrian location, and
transmit instructions to issue an alert via the user device in response to the image data indicating the presence of the obstruction.

18. The system of claim 17, wherein the sensor is at least one of a camera, LIDAR, radar, or ultrasonic sensor.

19. The system of claim 17, wherein the sensor is included in a device associated with the pedestrian including one of a mobile user device, a wearable device, or a walking aid device.

20. The system of claim 17, wherein the sensor is included in the user device associated with the pedestrian, the user device being one of a mobile user device, a wearable device, vehicle, smart device, and traffic infrastructure device, the sensor being remote from the pedestrian location.
